(19) United States
(12) Patent Application Publication
(10) Pub. No.: US 2020/0271363 A1
(43) Pub. Date: Aug. 27, 2020

(54) Refrigerant Charging Safety Valve Assembly

(71) Applicant: Thermofluid Technologies, Inc., Louisville, TN (US)

(72) Inventor: Floyd Eugene Brewer, II, Maryville, TN (US)

(21) Appl. No.: 16/804,935

(22) Filed: Feb. 28, 2020

Related U.S. Application Data
(63) Continuation-in-part of application No. 16/691,790, filed on Nov. 22, 2019.
(60) Provisional application No. 62/772,832, filed on Nov. 29, 2018.

(51) Int. Cl. F25B 45/00; F25B 49/00; B60H 1/00

(52) U.S. Cl. CPC F25B 45/00; F25B 49/005; B60H 2001/3248; F25B 2345/006; F25B 2345/001; B60H 1/00585

(57) ABSTRACT

A refrigerant charging safety valve assembly for delivering refrigerant to a vehicle's air conditioning system. The refrigerant charging safety valve assembly includes a can tap valve body, a pressure-measuring gauge secured to a first fluid port of the valve body, a hose secured to a second fluid port of the valve body, and a quick connect coupling adapted for connecting the hose to a vehicle A/C system charging port . The pressure measuring gauge is provided for measuring the pressure of the vehicle's air conditioning system when connected to the vehicle's charging port. The refrigerant charging safety valve assembly is specifically adapted to allow or inhibit flow of refrigerant from the pressurized refrigerant container through the refrigerant charging safety valve assembly to the vehicle's charging system.

### CROSS-REFERENCE TO RELATED APPLICATIONS

This application claims the benefit of U.S. Non-Provisional patent application Ser. No. 16/691,790, filed on Nov. 22, 2019, which in turn claimed the benefit of U.S. Provisional Patent Application No. 62/772,832, filed on Nov. 29, 2018, each of which is incorporated herein in its entirety by reference.

### STATEMENT REGARDING FEDERALLY SPONSORED RESEARCH OR DEVELOPMENT

Not Applicable

### BACKGROUND OF THE INVENTION

### 1. Field of Invention

The invention relates to a device for delivering a refrigerant into an air conditioning system. More particularly, it relates to a refrigerant delivery device that is adapted to allow determination of the system pressure independently from the pressure of the supply cannister and to allow for changing of refrigerant supply cannister while connected to the vehicle supply port.

### 2. Description of the Related Art

In the field of vehicles, such as, but not limited to automobiles, cars, trucks, and other types of motorized vehicles, it is known that that an air conditioning system removes humidity from, and cools, ambient air within the vehicle's cabin. As is known by those skilled in the art, the air conditioning systems in vehicles utilize various refrigerants such as R-12. R-12, and related refrigerants, have been made commercially available and sold under the trademark Freon®. In recent years other refrigerants such as R-134A, and other known state-of-the-art refrigerants, such as R-1234yf have been used. Those skilled in the art will recognize that R-1234yf is replacing R-134A. It is known in the art that R-1234yf is flammable; and while the toxicity of R-1234yf is being debated, it is known that various of the gases formed by combustion of R-1234yf are toxic. Further, other refrigerants, such as various mixtures of propane and butane have been formulated to replace refrigerants such as R-12 and R-134A due to the harmful effects of these refrigerants on the atmosphere. U.S. Patent No. 6,336,333, issued to Gary Lindgren on Jan. 8, 2002, claims such an alternate refrigerant as a substitute for R-12.

Also, it will be readily recognized by those skilled in the art that a state-of-the-art vehicle air conditioning system requires periodic maintenance in regard to replenishing the amount of refrigerant within the system. Replenishing the amount of refrigerant within the vehicle's air conditioning system requires connecting a supply of refrigerant to the vehicle's low-pressure A/C port. This process can easily be performed by the owner of the vehicle; and, increasingly, commercial, public auto parts stores sell canisters of refrigerant and various devices for connecting the cannister of refrigerant to the low-pressure A/C system charging port to recharge the system. In this regard, it is known in the art that various commercially available recharging kits utilize trigger-actuated valves having plastic components that are not compatible with state-of-the-art flammable refrigerants.

What is missing from the art is a refrigerant charging safety valve assembly that is adapted to be secured to a cannister of refrigerant and that is also adapted to allow determination of the system pressure independently of the supply cannister and allow for changing of refrigerant supply cannisters while connected to the vehicle A/C system charging port.

### BRIEF SUMMARY OF THE INVENTION

The refrigerant charging safety valve assembly of the present invention includes a can tap valve body that has a first fluid port adapted to be secured to a pressure-measuring gauge, a second fluid port adapted to be secured to the first end of a hose, and a third fluid port adapted to be releasably attached to a cannister of refrigerant for a vehicle A/C system. A second end of the hose is connected to a quick disconnect fitting to connect the refrigerant charging safety valve to the vehicle's A/C system charging port. Further, the refrigerant charging safety valve is adapted to have a gauge for measuring the pressure of the vehicle's A/C system when connected to the vehicle's A/C system charging port. The refrigerant charging safety valve of the present invention is adapted to detect the pressure of the vehicle's A/C system independently of the presence of a refrigerant supply cannister. Further, the refrigerant charging safety valve assembly of the present invention is specifically adapted to be allow for the refrigerant supply cannister to be removed from the refrigerant charging safety valve assembly while the refrigerant charging safety valve assembly is connected to the vehicle's A/C system charging port without venting and discharging the vehicle's A/C system. Further, a valve actuator is provided so as to selectively allow or inhibit flow of refrigerant from the refrigerant supply cannister through the refrigerant charging safety valve to the vehicle's charging system.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a perspective view of a portion of the refrigerant charging safety valve assembly of the present invention;

FIG. 2 is a sectional view of the refrigerant charging safety valve assembly as illustrated in FIG. 1;

FIG. 3 is a sectional view of the valve body of the refrigerant charging safety valve assembly of the present invention taken at circle A in FIG. 2;

FIG. 3 is a schematic sectional view of the refrigerant charging safety valve assembly, as illustrated in FIG. 1, having a refrigerant supply cannister attached thereto;

FIG. 4 is a partial sectional view of the refrigerant charging safety valve assembly as illustrated in FIG. 1 showing a schematic view of the refrigerant supply cannister threadably attached to the valve body; and

FIG. 5 is a perspective view of an alternate embodiment refrigerant charging safety valve assembly.

### DETAILED DESCRIPTION OF THE INVENTION

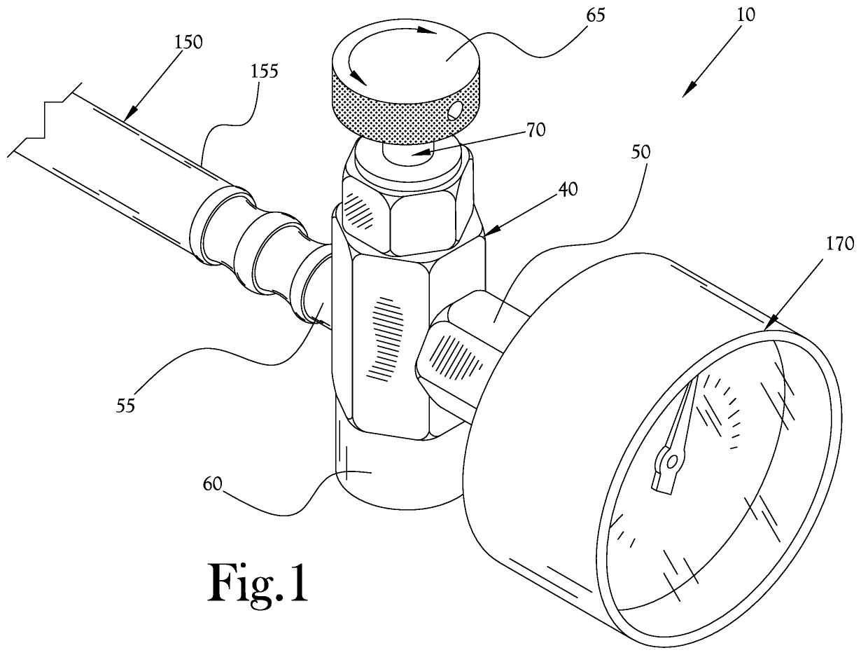

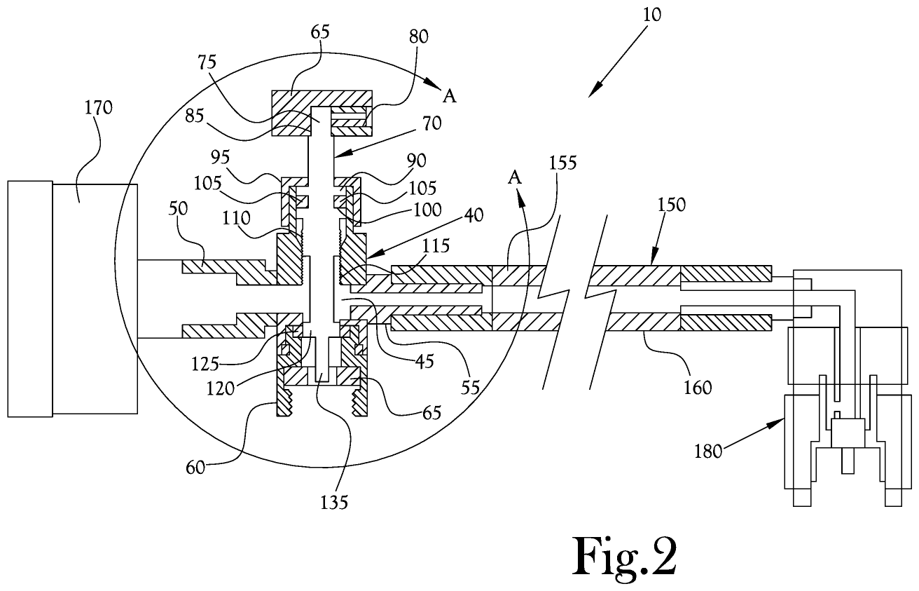

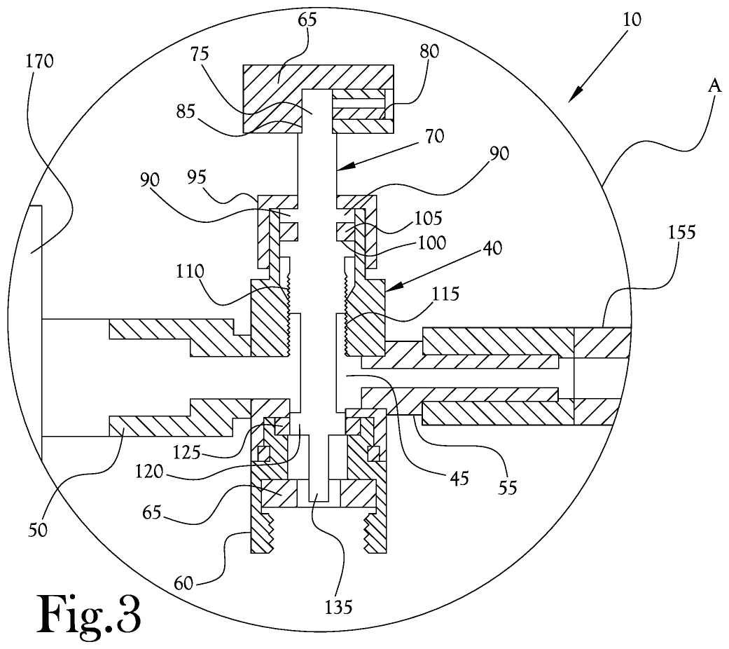

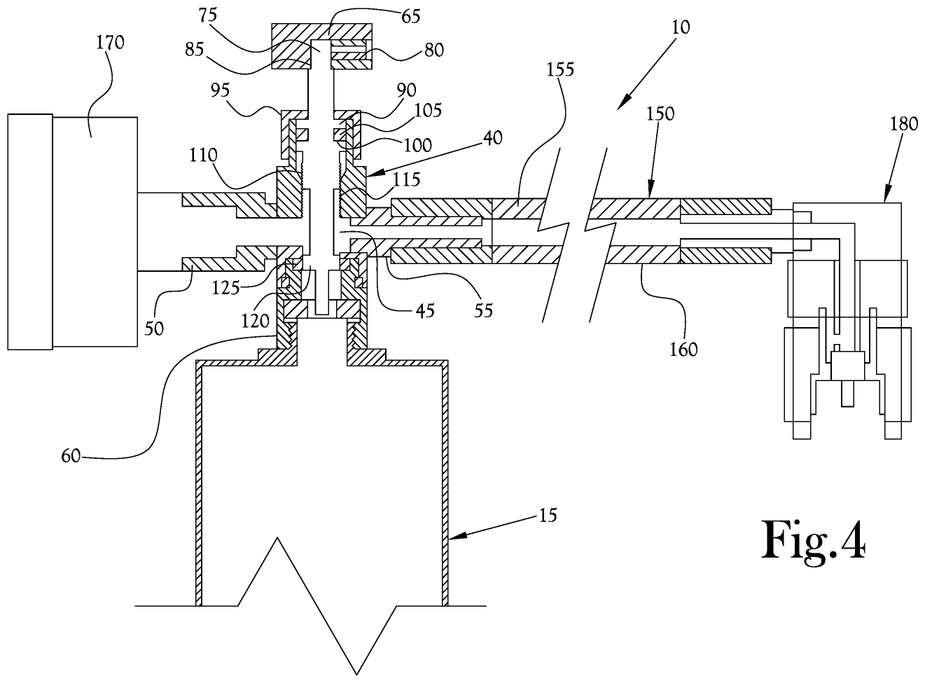

FIGS. 1-4 illustrate a refrigerant charging safety valve assembly 10. It will be appreciated by those skilled in the art that refrigerant is often supplied in a supply cannister 15, as will be recognized by those skilled in the art, is adapted for containing a refrigerant that can be discharged into a vehicle air conditioning system. In an exemplary embodiment, the discharge port of the pressurized refrigerant supply cannister 15 is defined by an externally threaded cylindrical outlet and includes a self-sealing valve that includes a spring-loaded gating device that is depressed to open and released to close the valve of the pressurized refrigerant supply cannister 15.

In an exemplary embodiment, the refrigerant charging safety valve assembly 10 of the present invention includes a can tap valve body 40, a hose 150, a pressure-measuring gauge 170, and a quick connect coupling 180 adapted for connecting the hose 150 to a vehicle A/C system charging port (not shown). It should be appreciated by those skilled in the art, that while the present invention is described herein as being used for recharging a vehicle's air conditioning system, the present invention also has utility and can be used for recharging the cooling system on appliances, such as wine coolers, refrigerators, and freezers. Further, the present invention could also be utilized to recharge the air conditioning system used in houses, apartments, and other buildings.

As indicated above, the refrigerant charging safety valve assembly 10 includes a can tap valve body 40 having an internal bore 45 and a first fluid port 50 adapted to be releasably coupled to pressure-measuring gauge 170. A second fluid port 55 is adapted to be secured to hose 150. Additionally, a third fluid port 60 is provided that is adapted to be threadably attached to the discharge port of the pressurized refrigerant supply cannister 15. In this regard, third fluid port 60 includes a seal member 65 for sealing the junction between the third fluid port 60 and the discharge port of the pressurized refrigerant supply cannister 15. Can tap valve body 40 further includes a valve actuator 65. Can tap valve body 40 further includes a piston member 70 adapted to allow the flow of refrigerant through the can tap valve body 40 and into hose 150 when a refrigerant supply cannister 15 is threadably secured to the refrigerant charging safety valve assembly 10. Further, piston member 70 is adapted to allow pressure-measuring gauge 170 to read the pressure of the system, i.e. the air conditioning system being charged, prior to actuating valve actuator 65.

In this regard, piston member 70 includes a first end 75 adapted to be secured to valve actuator 65. In an exemplary embodiment, valve actuator 65 is defined by a circular knob and includes a bore 85 that receives first end 75 of piston member 70. Valve actuator 65 is secured to the first end 75 of piston member 70, in an exemplary embodiment, by a hex head set screw 80. Thus, valve actuator 65 is adapted to engage and impart rotational movement to piston member 70. Further, piston member 70 includes an upper shoulder 90 for engaging cap 95. Cap 95 is threadably secured to the can tap valve body to prevent inadvertent removal of piston member 70. Piston member 70 is disposed and operative within the internal bore 45 for selectively preventing fluid communication between the supply cannister 15 and the internal bore 45 via third fluid port 60.

A circumferential groove 100 is provided on piston member 70, proximate the first end 75 of piston member 70. Circumferential groove 100 receives a sealing member 105 to prevent leakage of refrigerant past cap 95. Further piston member 70 includes a threaded region 110 that threadably engages an internal threaded region 115 disposed within can tap valve body 40. The engagement of threaded region 115 and threaded region 110 act to convert rotational movement of piston member 70, via valve actuator 65 to linear movement of piston member 70 within the internal bore 45 of the can tap valve body 40.

The lower end of the piston member 70 is defined by a valve actuating pin 135 which engages the sealing valve, described above, that allows refrigerant to flow from supply cannister 15. In this regard, the conversion of rotational movement of piston member 70, via valve actuator 65, to linear movement of piston member 70 within the internal bore 45 of the can tap valve body 40 causes pin member 135 to engage the valve of the supply cannister 15. In order to prevent evacuation of the A/C system when the quick connect coupling 180 is secured to the charging port of the A/C system being recharged with refrigerant, piston member 70 further includes a lower shoulder 120 which engages lower seal member 125 disposed within third fluid port 60.

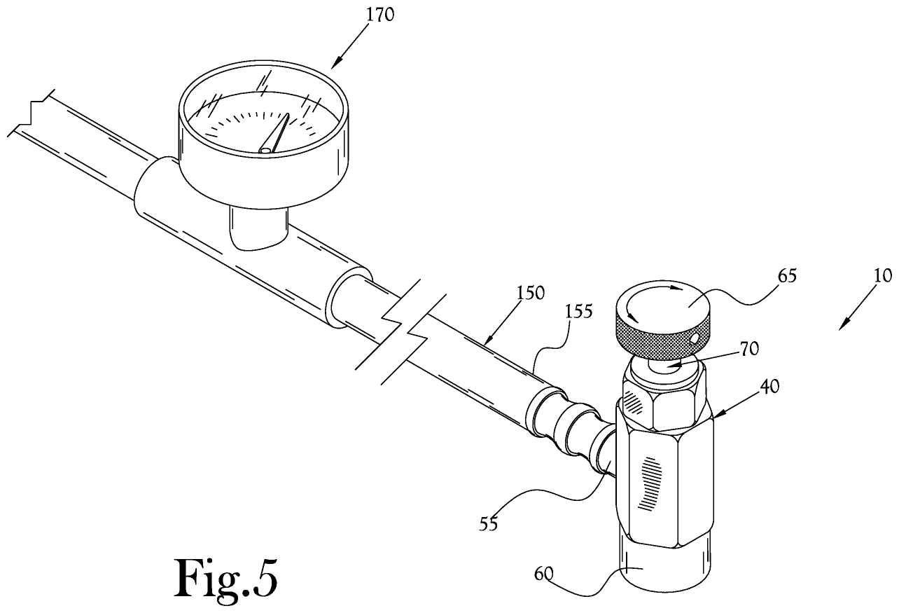

Pressure-measuring gauge 170 is in fluid communication with the internal bore 45 of can tap valve body 40 and is a standard pressure-measuring gauge adapted for pressures typical of the A/C system being recharged. As discussed above pressure-measuring gauge 170 is secured to first fluid port 50 of the can tap valve body 40. Further, in an exemplary embodiment of the present invention, a hose 150 is provided that is in fluid communication with the can tap valve body 40 by means of second fluid port 55, described above. Hose 150 is further in fluid communication with a quick connect coupling 180. In this regard, hose 150 has a first end 155 that is secured to second fluid port 55 and a second end that is secured to quick connect coupling 180. Quick connect coupling 180 in an exemplary embodiment is any commonly available flush-face type quick action coupling, such as the quick couplings that are compliant with ISO 16028. It will be appreciated by those skilled in the art that other similar quick connect couplings could also be used and that compliance with ISO 16028 is not required to be within the scope of the present invention. In alternate embodiment, illustrated in FIG. 5, pressure-measuring gauge 170 is secured to hose 150 and is disposed between the first end 155 of hose 150 and the second end 160 of hose 150 such that pressure-measuring gauge 170 is in fluid communication with the internal bore 45 of the can tap valve body 40.

While the present invention has been illustrated by description of several embodiments and while the illustrative embodiments have been described in detail, it is not the intention of the applicant to restrict or in any way limit the scope of the appended claims to such detail. Additional modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, what is claimed is:

1. A refrigerant charging safety valve assembly for charging an air conditioning system with refrigerant, said refrigerant charging safety valve assembly comprising:
a can tap valve body having an internal bore and a first fluid port in fluid communication with said internal bore, a second fluid port in fluid communication with said internal bore, and a third fluid port in fluid communication with said internal bore wherein said third port is adapted to be threadably secured to a refrigerant supply cannister;
a pressure-measuring gauge operatively connected to said first fluid port;
a hose having a first end secured to said second fluid port of said can tap valve body, and a second end;
a quick connect coupling secured to said second end of said hose;
a valve disposed within said internal bore of said can tap valve body for selectively actuating the refrigerant supply cannister having a self-sealing valve and is further adapted to substantially prevent evacuation of the air conditioning system when said quick connect coupling is secured to a charging port of the air conditioning system; and
a valve actuator carried by said can tap valve body for actuating said valve.

2. The refrigerant charging safety valve assembly of claim 1 wherein said valve disposed within said internal bore of said can tap valve body is defined by a piston member having a first end adapted to be secured to said valve actuator and wherein said valve actuator is adapted to engage and impart rotational movement to said piston member, said piston member further having a threaded region that threadably engages an internal threaded region disposed within said can tap valve body, whereby engagement of said threaded regions with one another act to convert rotational movement of said piston member via said valve actuator to linear movement of said piston member within said internal bore of said can tap valve body.

3. The refrigerant charging safety valve assembly of claim 2 wherein said valve actuator is defined by a circular knob and includes a bore that receives a first end of said piston member.

4. A refrigerant charging safety valve assembly for charging an air conditioning system with refrigerant, said refrigerant charging safety valve assembly comprising:
a can tap valve body having an internal bore and a first fluid port in fluid communication with said internal bore, a second fluid port in fluid communication with said internal bore, and a third fluid port in fluid communication with said internal bore wherein said third port is adapted to be threadably secured to a refrigerant supply cannister;
a pressure-measuring gauge operatively connected to said first fluid port;
a hose having a first end secured to said second fluid port of said can tap valve body, and a second end;
a quick connect coupling secured to said second end of said hose;
a valve disposed within said internal bore of said can tap valve body for selectively actuating the refrigerant supply cannister having a self-sealing valve and is further adapted to substantially prevent evacuation of the air conditioning system when said quick connect coupling is secured to a charging port of the air conditioning system, wherein said valve disposed within said internal bore of said can tap valve body is defined by a piston member having a first end adapted to be secured to said valve actuator and wherein said valve actuator is adapted to engage and impart rotational movement to said piston member, said piston member further having a threaded region that threadably engages an internal threaded region disposed within said can tap valve body, whereby engagement of said threaded regions with one another act to convert rotational movement of said piston member via said valve actuator to linear movement of said piston member within said internal bore of said can tap valve body; and
a valve actuator carried by said can tap valve body for actuating said valve.

5. The refrigerant charging safety valve assembly of claim 4 wherein said valve actuator is defined by a circular knob and includes a bore that receives a first end of said piston member.

6. A refrigerant charging safety valve assembly for charging an air conditioning system with refrigerant, said refrigerant charging safety valve assembly comprising:
a can tap valve body having an internal bore and a first fluid port in fluid communication with said internal bore, a second fluid port in fluid communication with said internal bore, and a third fluid port in fluid communication with said internal bore wherein said third port is adapted to be threadably secured to a refrigerant supply cannister;
a pressure-measuring gauge secured to said hose such that said pressure-measuring gauge is in fluid communication with said internal bore of said can tap valve body;
a hose having a first end secured to said second fluid port of said can tap valve body, and a second end;
a quick connect coupling secured to said second end of said hose;
a valve disposed within said internal bore of said can tap valve body for selectively actuating the refrigerant supply cannister having a self-sealing valve and is further adapted to substantially prevent evacuation of the air conditioning system when said quick connect coupling is secured to a charging port of the air conditioning system; and
a valve actuator carried by said can tap valve body for actuating said valve.

7. The refrigerant charging safety valve assembly of claim 1 wherein said valve disposed within said internal bore of said can tap valve body is defined by a piston member having a first end adapted to be secured to said valve actuator and wherein said valve actuator is adapted to engage and impart rotational movement to said piston member, said piston member further having a threaded region that threadably engages an internal threaded region disposed within said can tap valve body, whereby engagement of said threaded regions with one another act to convert rotational movement of said piston member via said valve actuator to linear movement of said piston member within said internal bore of said can tap valve body.

8. The refrigerant charging safety valve assembly of claim 2 wherein said valve actuator is defined by a circular knob and includes a bore that receives a first end of said piston member.
